(19) United States
(12) Patent Application Publication
(10) Pub. No.: US 2005/0270325 A1
(43) Pub. Date: Dec. 8, 2005

(54) System and method for calibrating ink ejecting nozzles in a printer/scanner

(76) Inventors: Barry R. Cavill, Lexington, KY (US); James L. Combs, Lexington, KY (US); Khageshwar Thakur, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/862,802

(22) Filed: Jun. 7, 2004

(51) Int. Cl. B41J 2/195

(52) U.S. Cl. 347/19

(57) ABSTRACT

A system and method are described for the calibration of ink ejecting nozzles in a device including an inkjet printer and a scanner. The ejecting nozzles form one or more pens in a printhead cartridge. The method includes the steps of printing a test pattern including a plurality of patches onto a sheet of material using the ink ejecting nozzles. The sheet of material having the test pattern printed thereon is scanned with the scanner and scanned data is produced for each of the patches. The scanned data is analyzed in a control to determine a selected patch based on its color density, and the ink ejecting nozzles are calibrated based upon the analysis.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to a system and method for automatically calibrating the ink ejecting nozzles in a device that includes both a printer and a scanner.

2. Description of the Related Art

All-in-one (AIO) or multifunction devices typically include an ink jet printer and a scanner and can be configured as stand-alone devices or can be coupled to a personal computer or network. These devices can also include a facsimile module.

The ink jet printer typically includes one or more printheads mounted on a carriage mechanism. The carriage mechanism is moveable in a direction that is transverse to an advance or feeding direction of a print medium such as paper. The printhead is moved in a series of passes across the print medium and during each pass, ink is selectively expelled from nozzles to form ink dots at corresponding ink dot placement locations in the image area of the print medium. Since the printhead moves in a direction transverse to the advance direction of the print medium, each ink ejecting nozzle passes in a linear manner over the print medium. A desired image is thus printed by the combination of lateral printing passes and longitudinal advances of the print medium. In some designs, the printhead is capable of bilateral operation, that is, it expels ink as it moves in a lateral direction across the paper both in a forward direction and in a reverse direction. Further, in some designs the ink jet printer includes a black printhead for printing black ink and a three-color printhead including pens for printing cyan, yellow and magenta ink. Other designs may include separate printheads for each color of ink or use of an additional three-color printhead, such as a photo-ink cartridge, having inks of different color density than those found in the other color printhead.

Print quality depends on precisely applying ink drops to the print media. This requires that the precise alignment of the printheads with respect to each another be ascertained, in both horizontal and vertical directions. For a printhead that prints in both forward and reverse directions horizontally across the sheet, ink drops from both directions also need to be precisely aligned.

### SUMMARY OF THE INVENTION

It is desirable to perform a calibration procedure upon the start up of an AIO device, and whenever a printhead is changed. Prior art calibration procedures for AIO devices often entail the printing of test patterns on a test sheet, and typically have not been automatic since manual intervention is required to interpret the various test patterns. Further, information relevant to the interpretation of a selected pattern must then be communicated in some manner to the AIO device. Thus, it is desirable to automate the analysis of test patterns in order to simplify and standardize the calibration procedure, in order to reduce the amount of user intervention required as well as the potential for human error.

The invention provides a system and method for the calibration of ink ejecting nozzles. The method is operable with a system that includes both an ink jet printer and a scanner. The method includes the steps of printing a test pattern including a plurality of patches onto a sheet of material with the ink ejecting nozzles and then scanning the sheet of material having the test pattern printed thereon with the scanner and producing scanned data for each of the patches. The scanned data is analyzed in a controller to determine a selected patch based on its color density, and the ink ejecting nozzles are calibrated based upon the analysis

Other features and advantages of the invention will become apparent to those skilled in the art upon review of the following detailed description, claims, and drawings.

### BRIEF DESCRIPTION OF THE DRAWINGS

FIG. 1 depicts one embodiment of an AIO system for implementing the method for calibrating the ink ejecting nozzles.

FIG. 2 illustrates one embodiment of the printheads including various pens and illustrating the ink ejecting nozzles.

FIG. 3 is a flow chart depicting the steps involved in one embodiment of the method for calibrating ink ejecting nozzles.

FIG. 4 depicts an example of a printed test pattern useful in a method for calibrating the ink ejecting nozzles.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. The order of limitations specified in any method claims does not imply that the steps or acts set forth therein must be performed in that order, unless an order is explicitly set forth in the specification.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

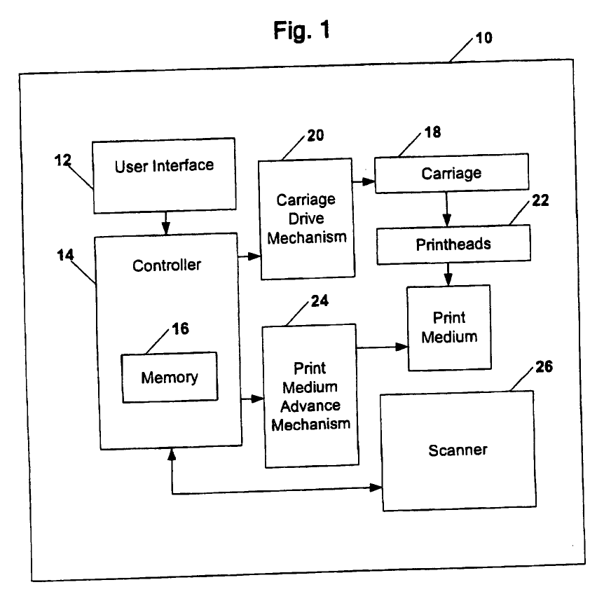

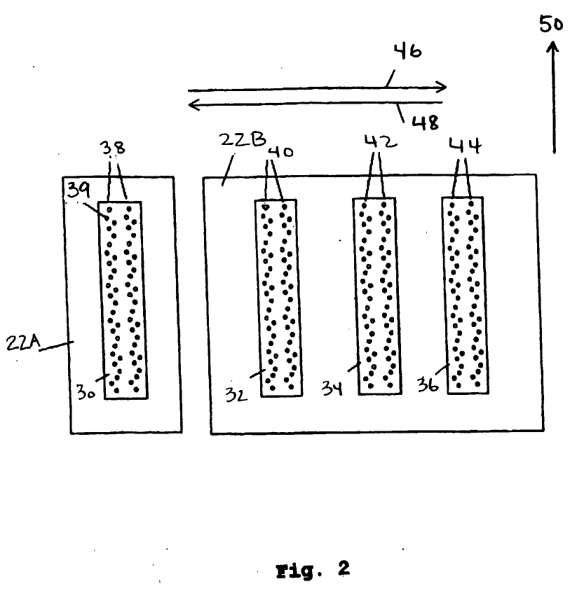

FIG. 1 illustrates a block diagram of one embodiment of an AIO system 10 for implementing the method for calibrating a plurality of ink ejecting nozzles. The system 10 includes a user interface 12, a controller 14 with memory 16, a carriage 18 for moving the printheads 22, a carriage drive mechanism 20, a print medium advance mechanism 24, and a scanner 26. The printheads 22 are in the form of replaceable cartridges. As shown in FIG. 2, a printhead includes one or more pens each having a plurality of ink ejecting nozzles that are selectively controlled to print on a print medium such as a sheet of paper. As known in the art, the scanner includes a scanning region where a sheet of material to be scanned is placed, and a scanning mechanism, such as an optical flatbed scanner, which is operable to scan a sheet of material in the scanning region. A sheetfed scanner can also be used where the material to be scanned is moved past the scanning mechanism. The scanner 26 produces scanned image data representative of the image on the sheet. The scanned image data is communicated to controller 14. The controller 14 is programmed to perform certain steps of a method for calibrating the ink ejecting nozzles, as more fully described below.

In the illustrated embodiment, AIO system 10 is a stand-alone device and is not coupled to a personal computer or computer network. In other embodiments, AIO system 10 can be coupled to a personal computer or computer network or the like. The present system and method are advantageous in that a stand-alone device can include auto-alignment capabilities.

FIG. 2 is a schematic view showing one embodiment of the ink ejecting nozzles for several ink jet pens on two or more printheads 22A, 22B. Specifically, FIG. 2 illustrates printhead 22A having a black pen 30 and a separate printhead 22B having color pens 32, 34, 36. Color pens 32, 34, and 36 may respectively print cyan, magenta, and yellow ink. As shown, pen 30 contains a nozzle array 38 containing a plurality of ink ejecting nozzles 39. Likewise, pen 32 contains nozzle array 40, pen 34 contains nozzle array 42, and pen 36 contains nozzle array 44. As is known, the arrangement of the pens on the printheads and the number of pens and printheads can vary from what is illustrated. For example, there may be only one printhead having two or more pens, at least two printheads each including one pen, at least two printheads each including at least two pens, or any combination of pens and printheads. Further, the arrangement of the nozzles in the nozzle array can vary from what is illustrated, as is known in the art.

The printheads are translated across a print medium in a forward horizontal direction 46 and ink drops are selectively expelled from the ink ejecting nozzles in a desired manner onto the print medium. The print medium can be, for example, a sheet of material such as paper. In addition to the horizontal translation of the printheads, the print media is advanced in a vertical direction 50. In the illustrated embodiment, the nozzles are operable to eject ink drops as the printheads are translated across the print media both in a forward direction 46 and in a reverse direction 48. In this manner, a desired image can be printed. The terms horizontal and vertical are only intended to show the relative motion between the print medium and the printheads which is that the printheads move in a direction that is substantially transverse to the motion of the print medium.

The quality and resolution of a printed image is a function of the number of nozzles, and the spacing between adjacent nozzles from the other pens. Despite the care taken to manufacture the pens, there is generally at least some misalignment, both horizontally and vertically, of the nozzles from their design locations. Also, because more than one pen can be attached to each printhead, and/or more than one printhead is attached to the carriage, there is a possible offset between the nozzle arrays of the separate printheads and between the nozzle arrays on a single multiple pen cartridge.

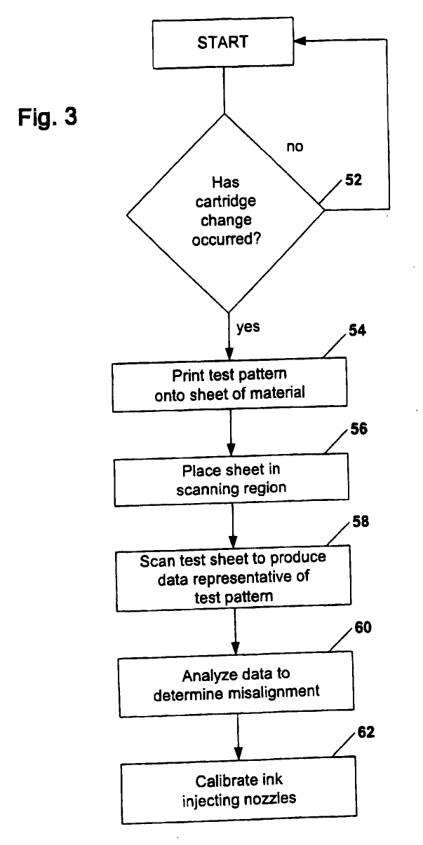

FIG. 3 illustrates a flow chart of the steps involved in a method for calibrating the ink ejecting nozzles between pens. At step 52, it is determined whether or not a printhead cartridge change has occurred. The system 10 may have automatic capabilities for identifying a printhead cartridge, for example, by reading an identification code or the like, and can thus detect when a cartridge change has occurred. Alternately, a user can specify, via the user interface 12 for example, that a printhead cartridge change has occurred.

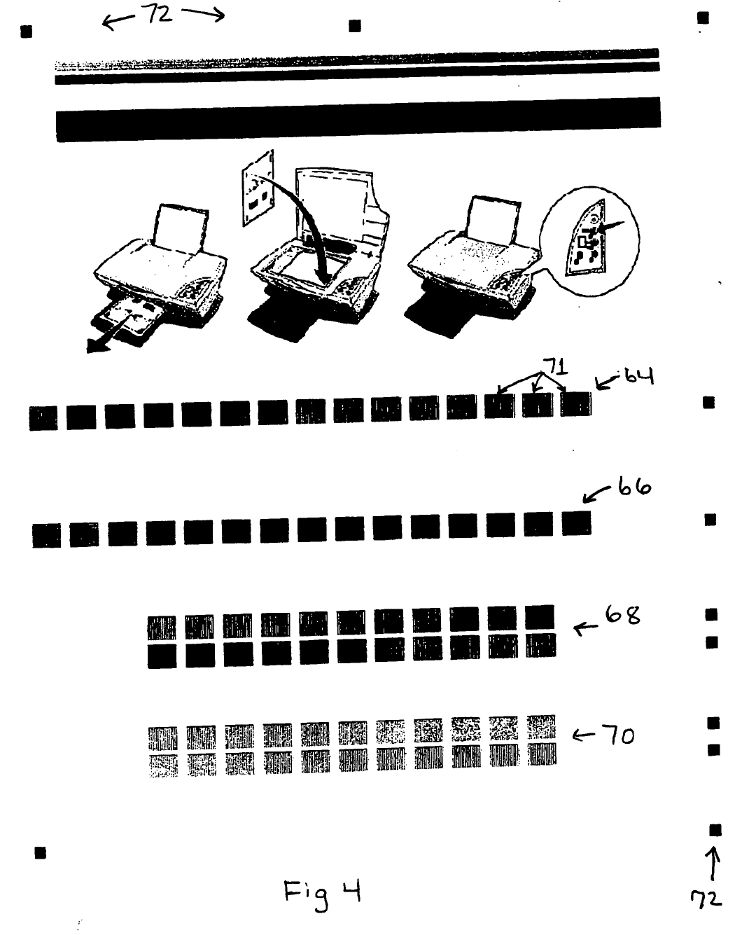

If a printhead cartridge change has occurred, if the printhead cartridge has been removed and then reinstalled or if requested by the user via the user interface (i.e. whenever removal of a printhead cartridge has been detected), at step 54, the system 10 is controlled to print a test pattern on a sheet of material to produce a test sheet. The test pattern, shown in FIG. 4 and explained in more detail below, includes a plurality of patches. The user is then instructed to place the printed test sheet on the scanning region of the device to scan the test sheet with scanner 26. Instructions to the user can be in the form of illustrations and/or written commands that are included on the test sheet, such as shown in FIG. 4, or displayed on the user interface 12.

In step 56, the test sheet is placed in the scanning region or fed through the sheetfed scanner. As the test sheet is scanned by the scanner at step 58, the scanner 26 produces scanned data representative of the test pattern that is then communicated to the controller 14. The scanned data is analyzed by the controller 14 at step 60 to select one of the patches based an evaluation of its color density, as more fully described below, to thereby determine the misalignment between ink ejecting nozzles from two or more pens. At step 62, the ink ejecting nozzles are calibrated based on the results of the analyzing step.

FIG. 4 depicts one embodiment of a printed test sheet to be used in connection with the algorithm described in relation to FIG. 3, and includes groups 64, 66, 68, 70 of multiple patches 71. Although shown as rectangular, the patches 71 need not be rectangular but can be any of a variety of shapes. Further, the number of patches in each group may vary from what is illustrated. The patches are comprised of a plurality of sub-elements and the groups of patches are similar in many respects to the pattern sets that are illustrated in U.S. Pat. No. 6,450,607 (the '607 Patent), assigned to the same assignee of the present application, and hereby incorporated by reference.

In particular, as shown in FIG. 4, a patch in group 64 includes a plurality of sub-elements that extend in a vertical direction (i.e., the direction in which the media is fed through the printer). In each patch, a first pen prints a first portion of the sub-elements, and a second pen prints a second portion of the sub-elements. For example, the first pen can be black pen 30 and the second pen can be magenta pen 34. In one embodiment, the first pen prints every other sub-element, and the second pen prints the remaining sub-elements. The position of the second portion of the sub-elements with respect to the first portion of the sub-elements is varied in a known way from one patch to the next. The patches in group 64 are similar to the vertical line segments illustrated as line D of FIG. 5 of the '607 Patent, but include more line segments. A single patch in group 64 of the present test pattern corresponds to one of the numerically labeled sets of vertical line segments in line D of FIG. 5 of the '607 Patent.

Similarly, group 66 of FIG. 4 illustrates patches having sub-elements that extend in a horizontal direction (i.e., the direction which is transverse to the direction of the media as it is fed through the printer). In each patch, a first pen prints a first portion of the sub-elements and a second pen prints a second portion of the sub-elements. The position of the second portion of the sub-elements with respect to the first portion of the sub-elements is varied in a known way from one patch to the next. The patches in group 66 are similar to the horizontal line segments illustrated as line G of FIG. 6 of the '607 Patent, but include more line segments. In particular, a single patch in group 66 corresponds to one of the numerically labeled sets of horizontal line segments in line G of FIG. 6 of the '607 Patent.

Group 68 of FIG. 4 also illustrates patches having sub-elements that extend in a vertical direction (i.e., the direction in which the media is fed through the printer). In each patch, a first pen prints a first portion of the sub-elements when the printhead is moved in a first horizontal direction (e.g., the forward direction 46 as shown in FIG. 2), and the first pen prints a second portion of the sub-elements when the printhead is moved in the opposite direction (e.g., the reverse direction 48 as shown in FIG. 2). The position of the second portion of the sub-elements with respect to the first portion of the sub-elements is varied in a known way from one patch to the next. The patches in group 68 are similar to the vertical line segments shown in line A of FIG. 4 of the '607 Patent. In particular, a single patch in group 68 corresponds to one of the numerically labeled sets of vertical line segments in line A of FIG. 4 of the '607 Patent. The patches in group 70 are similar to those in group 68, but are printed with a second ink color from the printhead traveling in a first and a second horizontal direction.

In the embodiment illustrated, the test sheet also includes a set of fiducial marks 72. The fiducial marks 72 are non-symmetric with respect to the horizontal and/or vertical directions of the test sheet and are useful in the analyzing step 60 to determine the orientation of the test sheet in the scanning region.

The analyzing step 60 is automatically performed by the controller 14 and includes, in one embodiment, determining the orientation of the sheet, based on using the scanned data to determine the location of fiducial marks. Once the orientation of the sheet is determined, the location of the various patches can be ascertained as being at a known distance with respect to the marks, and having a known size. From the scanned data, the pixels corresponding to each patch are then identified, and a color value is calculated for each patch. In one embodiment, the color value that is determined is a gray scale optical density. The controller then determines a selected patch in each group based upon its color value. For example, the controller can be programmed to select which patch in each group is the darkest patch, that is, the patch having the highest optical density. A patch having second sub-elements right on top of the first sub-elements would have an optical density much less than a patch having the second sub-elements equally spaced between the first sub-elements. Alternatively, the controller 14 can be programmed to select which patch in each group in the lightest patch.

In any event, a patch is selected based on its optical density compared to the others in group 64. The horizontal alignment of the ink ejecting nozzles of the first ink pen with respect to the second ink pen can be calculated, in a manner similar to that described in the '607 Patent. The controller 14 calculates the actual values of the horizontal offsets between nozzles based on the selected patch location and knowledge of the theoretical offsets between the first and second portions of sub-elements in each patch. Similarly, a patch is selected from group 66 based on its optical density, and the vertical alignment of the nozzles of the first ink pen with respect to the second ink pen is also calculated. The controller calculates the actual values of the vertical offsets between nozzles based on the selected patch location and knowledge of the theoretical offsets between the first and second portions of sub-elements in each patch.

This analysis can also be performed for the ink ejecting nozzles of a third and fourth pen with respect to the first pen (or with respect to the second pen), using additional groups of patches with sub-elements from the first and third pen, and from the first and fourth pen, as described in the '607 Patent.

Further, the analysis can be performed to determine the misalignment of ink drops printed by a single ink pen printed in a forward horizontal direction compared to the reverse horizontal direction, as also described in the '607 Patent, using the groups 68, 70, and the theoretical offsets between the first and second portions of sub-elements in each patch.

The '607 Patent requires a user to manually select either the best-aligned vertical segments or horizontal segments, and provide this information to the printer controller. In the present method, the controller 14 automatically determines the darkest patch for example, and automatically uses this information to calculate actual offsets between ink drops from nozzles from one pen compared to another pen.

The calibrations that occur are known to those skilled in the art. For example, the horizontal alignment of nozzles from two pens may be accomplished by delaying or advancing the ejection of ink drops from one of the pens with respect to the other. For vertical alignment, a selected subset of nozzles of a first pen can be chosen to be enabled during each horizontal print swath such that the ink drops are aligned with those from a second selected subset of nozzles from a second pen. In other words, a small percentage of the printhead nozzles are unused to allow the print swath to be moved vertically.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

1. A method for the calibration of ink ejecting nozzles in a system including an inkjet printer and a scanner, the method comprising:
printing a test pattern including a plurality of patches onto a sheet of material with the ink ejecting nozzles;
scanning the sheet of material having the test pattern printed thereon with the scanner and producing scanned data for each of the patches;
analyzing the scanned data in a controller to determine a selected patch based on its color density; and
calibrating the ink ejecting nozzles based upon the analysis.

2. The method of claim 1, wherein the patches each include a plurality of sub-elements and for each patch a first pen prints a first portion of the sub-elements and a second pen prints a second portion of the sub-elements, and the location of the second portion of the sub-elements with respect to the first portion of the sub-elements varies in a known manner from patch to patch.

3. The method of claim 2, wherein the calibrating step includes adjusting the timing of ejecting ink drops from the ink ejection nozzles.

4. The method of claim 2, wherein the calibrating step includes selecting a portion of the ink ejecting nozzles in the first pen to vertically correspond to a selected portion of ink ejecting nozzles in the second pen.

5. The method of claim 1, wherein the patches each include a plurality of sub-elements and for each patch a pen traveling in a forward direction prints a first portion of the sub-elements and the same pen traveling in the reverse direction prints a second portion of the sub-elements, and the location of the second portion of the sub-elements varies in a known manner from patch to patch.

6. The method of claim 5, wherein the calibrating step includes adjusting the timing of ejecting ink drops from the ink ejection nozzles.

7. The method of claim 1, wherein the printing step also includes printing a plurality of fiducial marks on the sheet of material.

8. The method of claim 7, wherein the analyzing step includes using the fiducial marks to determine the orientation of the sheet of material in a scanning region of the scanner.

9. The method of claim 7, wherein the analyzing step includes using the fiducial marks to locate the patches on the sheet of material so that the scanned data corresponding to each of the patches can be ascertained.

10. The method of claim 1, including the further step of detecting that a printhead cartridge change has occurred prior to the printing step.

11. The method of claim 1, wherein the scanner is chosen from a group consisting of an optical flatbed scanner and a sheetfed scanner.

12. The method of claim 1, wherein a user initiates the scanning step.

13. The method of claim 1, wherein the ink jet printer includes at least two pens and the analyzing step includes determining the offset of the nozzles of each pen with respect to the others.

14. The method of claim 13, wherein the analyzing step includes determining the vertical offset of the nozzles of each pen with respect to the other pens.

15. The method of claim 13, wherein the analyzing step includes determining the horizontal offset of the nozzles of each pen with respect to the other pens.

16. The method of claim 1, wherein the analyzing step includes determining an optical density of each patch.

17. The method of claim 16, wherein the darkest patch is selected.

18. The method of claim 16, wherein the lightest patch is selected.

19. The method of claim 1, wherein the calibrating step includes adjusting the timing of ejecting ink drops from the ink ejection nozzles.

20. The method of claim 1, wherein the calibrating step includes selecting a portion of the ink ejecting nozzles from a first pen to vertically correspond to a selected portion of ink ejecting nozzles from a second pen.

21. A system for the calibration of ink ejecting nozzles comprising:
a controller,
an ink jet printer including a printhead cartridge having a plurality of ink ejecting nozzles and under the operation of the controller for printing a test pattern including a plurality of patches onto a sheet of material with the ink ejecting nozzles to produce a test sheet; and
a scanner under the operation of the controller for scanning the test sheet and producing scanned data for each of the patches;
wherein the controller analyzes the scanned data to determine a selected patch based on its color density, and computes calibration values for the ink ejecting nozzles based upon the analysis.

22. The system of claim 21, wherein the patches each include a plurality of sub-elements and for each patch a first pen comprising of a first portion of the plurality of ink ejecting nozzles prints a first portion of the sub-elements and a second pen comprising a second portion of the plurality of ink ejecting nozzles prints a second portion of the sub-elements, and the location of the second portion of the sub-elements with respect to the first portion of the sub-elements varies in a known manner from patch to patch.

23. The system of claim 21, wherein the patches each include a plurality of sub-elements and for each patch a pen comprising a first portion of the plurality of ink ejecting nozzles while traveling in a forward direction prints a first portion of the sub-elements and the same pen traveling in the reverse direction prints a second portion of the sub-elements, and the location of the second portion of the sub-elements varies in a known manner from patch to patch.

24. The system of claim 21, wherein the test sheet also includes a set of fiducial marks, and the controller analyzes scanned data representing the fiducial marks to determine the orientation of the test sheet in a scanning region of the scanner.

25. The system of claim 21, wherein the controller instructs the ink jet printer to print the test sheet when a determination is made that a printhead cartridge change has occurred.

26. The system of claim 21, wherein the scanner is selected from a group consisting of an optical flatbed scanner and a sheet fed scanner

27. The system of claim 22, wherein the patches each include sub-elements where one set of sub-elements are vertically offset from the nozzles of one pen with respect to the other.

28. The system of claim 23, wherein the patches each include sub-elements where one set of sub-elements are vertically offset from the nozzles of one pen with respect to the other.

29. The system of claim 21, wherein the ink jet printer further comprises at least two printhead cartridges, with one of the printhead cartridges having a plurality of ink ejecting nozzles comprising at least one pen and at least one of the other printhead cartridges having a plurality of ink ejecting nozzles forming at least two pens wherein the controller analyses patches printed by each of the pens and computes calibration values for each pen of each printhead cartridge.
